(19) United States
(12) Patent Application Publication
(10) Pub. No.: US 2003/0234724 A1
(43) Pub. Date: Dec. 25, 2003

(54) Safety brake light the structure capable of displaying traveling condition and speed of the car

(76) Inventor: Chih-Ping Chiu, Keelung (TW)

Correspondence Address: Keith Kline, PRO-TECHTOR INTERNATIONAL SERVICES, 20775 Norada Court, Saratoga, CA, 95070-3440, US

(21) Appl. No.: 10/180,799

(22) Filed: Jun. 25, 2002

(51) Int. Cl. B60Q 1/50

(52) U.S. Cl. 340/464; 340/479; 340/466

(57) ABSTRACT

A safety brake light structure capable of displaying traveling conditions and speed of a car includes a display panel formed by a face panel formed by multiple color light emitting diodes, high-luminosity L.E.D., and a numeric display. The display panel is connected to a computer device. The computer device is connected to an accelerator pedal shift, a reversing shift, a braking shift and turn signal lights. The display panel is mounted at the front and rear windows of the car, whereby different colors of the face panel and numbers are used to indicate different traveling conditions and speed of the car so as to enhance safety.

### BACKGROUND OF THE INVENTION

(a) Field of the Invention

The invention relates to a safety brake light structure capable of displaying traveling condition and speed of a car, more particularly to a safety brake light structure that can display acceleration, deceleration, braking, reversing, and turning states of the car, and the speed of the car.

(b) Description of the Prior Art

When a driver wants to brake his car, he controls a third brake light, which gives off a red warning light, to warn the car following him so as to avoid possible collision. However, when cars are moving at a high speed, and a car in front suddenly decelerates without any warning due to release of the gas or accelerator pedal or due to failure of a certain mechanical part, tire puncture, or ignition problem, without any warning, the car following it may collide thereinto. Further, when a driver wants to go past a car in front, it is difficult for him to perceive the driving condition of the car in front and accidents may occur as a result. For cars traveling at 60 to 90 kilometers per hour on a highway, it takes about two to four seconds for the driver to perceive that the car in front is has decelerated. Therefore, to give the driver more time to respond to the driving condition of a car in front can effectively enhance driving safety.

Furthermore, at a crossroad without any traffic lights, pedestrians cannot positively determine whether the cars moving at a crossroad are in an accelerating state or in a decelerating state when trying to cross the crossroad, which is very dangerous. And if a driver inadvertently steps on the accelerator pedal when trying to brake, an accident may result. As the existing brake light cannot reflect the aforesaid driving conditions, improvement is necessary (See attachment 1).

### SUMMARY OF THE INVENTION

Therefore, the primary object of the invention is to provide a safety brake light structure capable of displaying traveling conditions and speed of a car, and is mounted at front and rear windows of the car to display acceleration, deceleration, reversing, braking states of the car and the speed of the car so as to ensure safety.

The aforesaid brake light structure includes a display panel formed by a face panel formed by multiple color light emitting diodes, high-luminosity L.E.D., and a numeric display. The display panel is connected to a computer device. The computer device is connected to an accelerator pedal shift, a reversing shift, a braking shift and turn signal lights to display different traveling conditions and speed of the car so as to enhance safety.

In the aforesaid brake light structure, the display panel is mounted at the front window of the car and has front and rear surfaces provided with face panels of the same colors and numeric displays for viewing by the driver at the same time.

In the aforesaid brake light structure, the acceleration, deceleration, reversing and braking conditions of the car are shown in different colors on the face panel for viewing by the car behind, pedestrians and the driver so as to facilitate determination of the traveling condition of the car.

In the aforesaid brake light structure, both sides of the display panel are respectively provided with curved signal lights for displaying left and right turning of the car.

### BRIEF DESCRIPTION OF THE DRAWINGS

The foregoing and other features and advantages of the present invention will be more clearly understood from the following detailed description and the accompanying drawings, in which,

FIG. 1 is a block diagram of the device of the present invention;

FIGS. 2 and 3 are schematic views of the preferred embodiment of the present invention, which is mounted at the front window of a car; and

FIG. 4 is a schematic view of the preferred embodiment of the present invention, which is mounted at the rear window of the car.

### DETAILED DESCRIPTION OF THE PREFERRED EMBODIMENT

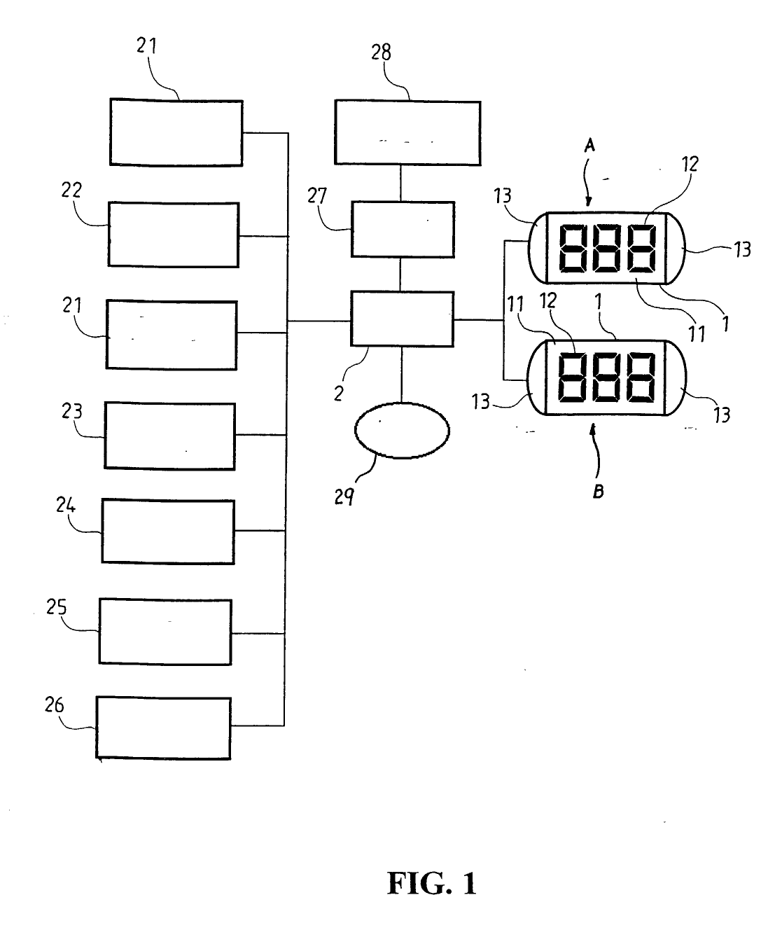

Referring to FIG. 1, the present invention includes a display panel 1 which is provided with a face panel 11 formed by multiple color light emitting diodes, and a numeric display 12, both sides of which are respectively provided with independent turn signal display lights 13. The display panel 1 is configured to be a single-sided or a double-sided display for mounting at the front or rear window of a car.

The display panel 1 is connected to a computer device 2, which is coupled to an accelerator pedal 21, a braking shift 22, a reversing shift 23, a speed display shift 24, and a turn signal shift 25 so that the face panel 11 displays different colors, the numeric display 12 displays the speed of the car, and the turn signal display lights 13 displays left or right turning of the car when the car is traveling in any state.

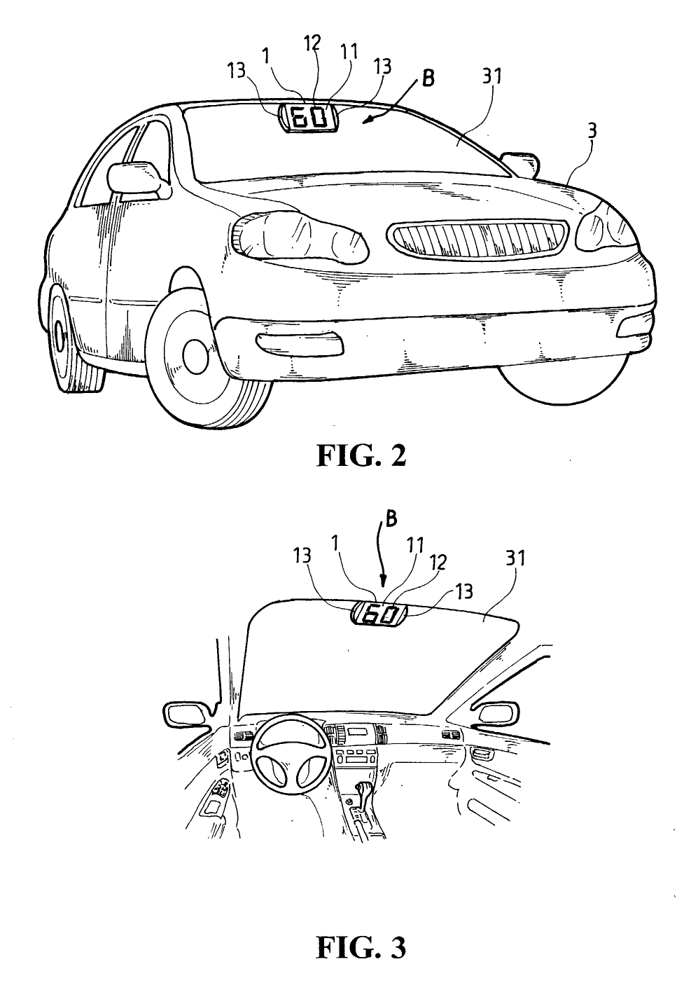

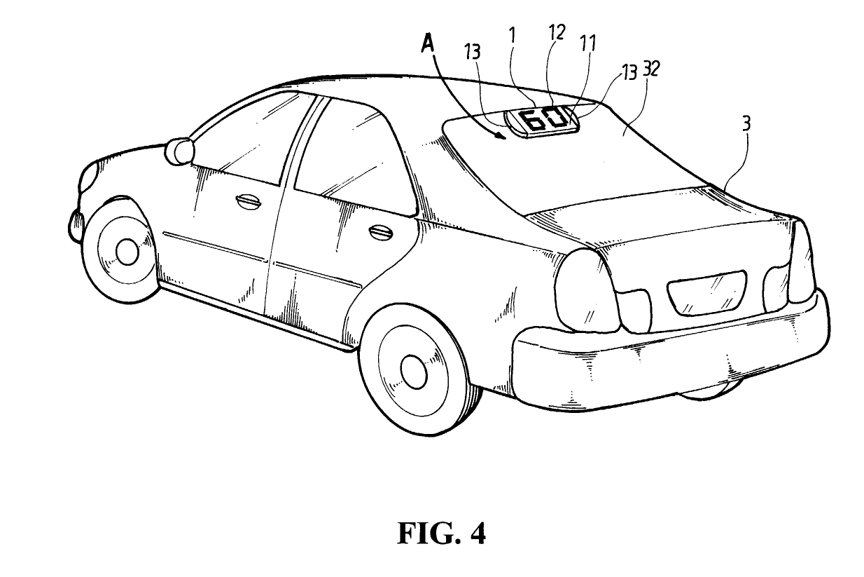

In the aforesaid construction, the display panel 1 can, as shown in FIGS. 2, 3 and 4, be mounted at a front window 31 and a rear window 32 in suitable positions. As the display panel 1 mounted at the front window 31 is a double-sided type, the display panel 1 can also be viewed from within the car. The operation of the entire brake light structure works in the following manners (the colors being used for exemplification purposes):

1. When the driver steps on the accelerator pedal, the face panel 11 is caused to light up and show a green color via the accelerator shift 21, and the digits indicating the speed of the car is yellow.

2. When the driver brakes the car, the face panel 11 is caused to show a red color via the braking shift 22.

3. When the driver releases the accelerator pedal, or the accelerator pedal shift 21, the braking shift 22, the reversing shift 23 are not actuated, the face panel 11 shows an orange color.

4. When the driver backs the car, the face panel 11 is caused to show a blue color via the reversing shift 23.

5. When the car moves or reverses, the speed of the car is indicated in yellow on the numeric display 12 via the speed display shift 24, and a buzzer 26 is activated to warn nearby cars or pedestrians.

6. When the car turns left or right, the turn signal shift 25 causes the left or right turn signal display light 13 to be on. When both of the turn signal display lights 13 are on, it indicates that the car is in trouble.

In addition, as the numeric display 12 is provided to facilitate identification, it is set to indicate a change in speed in units of 5 km (e.g., 0, 5, . . . 55, 60, . . . 90 . . . ).

Summing up the above, the present invention has at least the following advantages:

1. When a posterior safety brake light A is in use, the driving speed can be displayed and different colors are used to warn a car behind of the traveling condition of the car so as to avoid possible collision, and when the car behind tries to get pass the car in front, the former can get hold of the movement of the car in front to avoid undesirable accidents.

2. When the anterior and driver seat safety brake light B is in use, it can warn the car in front or the pedestrians of the movement of the car to ensure road safety. For instance, it can warn teachers and children to make sure that the cars on both sides of a crossing have come to a complete halt (the red brake light being on, and the speed displayed being zero) before crossing the road to thereby prevent occurrences of accidents and reduce violations of traffic regulations.

3. The driver can clearly observe the condition of the car to prevent stepping on the accelerator pedal when trying to brake the car, thereby reducing occurrences of accidents.

4. When the anterior safety brake light is in use, it can take the place of the headlight with a better effect. The major reason is that (1) the anterior safety brake light is in a prominent position; (2) the provides information regarding speed and direction of the car to warn nearby cars; and (3) the use of light emitting diodes is energy-saving and can reduce consumption of electric power of the car and gas.

In addition, the present invention can help save traffic police forces and resources and reduce use of speed detecting instruments. The car speed LED digital display device of the present invention can be installed at the front and rear ends of the car to enable people or police officers to read the speed of the car and take pictures of the car as evidence for speeding, and the speed of the car and the license plate can be simultaneously shown on the pictures. Thus, drivers have to control the speed of the car to be within safety limits so as to avoid accidents and ensure their safety as well as the safety of the pedestrians.

Although the present invention has been illustrated and described with reference to the preferred embodiment thereof, it should be understood that it is in no way limited to the details of such embodiment but is capable of numerous modifications within the scope of the appended claims.

Attachment: A table of comparison between the present invention and patents relating to improved third brake lights.

What is claimed is:

1. A safety brake light structure capable of displaying traveling condition and speed of a car, comprising a display panel, said display panel being provided with a face panel formed by multiple color light emitting diodes and a numeric display, two side thereof being respectively provided with turn signal display lights, said display panel being mounted at front and rear windows of the car in suitable positions, and being connected to a computer device, said computer device being connected to an accelerator pedal shift, a braking shift, a reversing shift and turn signal lights such that any traveling condition of the car can be displayed by said display panel using different color displays and with said numeric display displaying speed of the car so as to ensure safety.

2. The safety brake light structure capable of displaying traveling condition and speed of a car as claimed in claim 1, wherein said display panel that is mounted at the front window of the car is formed as a double-sided display type for viewing by the driver.

3. The safety brake light structure capable of displaying traveling condition and speed of a car as claimed in claim 1, wherein said numeric display indicates a change in speed of the car in units of five kilometers.
